(19) United States
(12) Patent Application Publication
(10) Pub. No.: US 2010/0101221 A1
(43) Pub. Date: Apr. 29, 2010

(54) CATALYSTS, SYSTEMS, AND METHODS FOR REDUCING NOx IN AN EXHAUST GAS

(75) Inventors: Sylvain Joseph Charbonnel, Peoria, IL (US); Zhiyong Wei, Chicago, IL (US); James Joshua Driscoll, Dunlap, IL (US); Ronald Silver, Peoria, IL (US); Corey Stefanick, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/259,339

(22) Filed: Oct. 28, 2008

(51) Int. Cl. F01N 3/10; B01J 27/24; B01J 31/12; F01N 3/00; B01J 23/50

(52) U.S. Cl. 60/301; 502/200; 502/150; 502/317; 60/274

(57) ABSTRACT

Catalysts, systems, and methods disclosed herein provide for reduced NOₓ emissions in the exhaust stream of a lean burning engine. The catalysts include two different types of selective catalytic reduction (SCR) catalysts (i.e., two different types of catalysts that may catalytically reduce NOₓ using a reductant). The first SCR catalyst (116) is an SCR catalyst having a composition that produces a reductant (e.g., an HC-SCR catalyst that produces ammonia) and the second catalyst (118) is an SCR catalyst (e.g., NH₃-SCR) having a composition that reduces NOₓ using the reductant produced by the first SCR catalyst (116).

### TECHNICAL FIELD

The present disclosure relates generally to exhaust emissions systems and catalysts for use in emissions systems of combustion engines.

### BACKGROUND

The fuel-air mixture used in an engine is selected to achieve desired performance characteristics in the combustion process. Fuel-air mixtures that include excess oxygen are known as “lean” mixtures and are used in lean-burning engines. Alternatively, if the mixture includes a stoichiometric amount or excess amount of fuel, the mixture is rich.

Exhaust from lean burning engines may include relatively high emissions of NOₓ as compared to combustions engines that operate under fuel rich conditions.

Conversion of the NOₓ component of exhaust streams to innocuous components generally requires specialized NOₓ abatement strategies for operation under fuel-lean conditions. Several catalytic systems for reducing NOₓ in the exhaust of lean burning engines are currently in use and/or under development. Examples of catalysts that may be used for abatement of NOₓ in the exhaust of lean burning engines include NOₓ storage reduction (NSR) catalysts, ammonia selective catalytic reduction (NH₃-SCR) catalysts, and hydrocarbon selective catalytic reduction catalysts (HC-SCR).

NSR catalysts (also known as “NOₓ traps”) contain NOₓ sorbent materials capable of adsorbing or “trapping” oxides of nitrogen under lean burning conditions and platinum group metal components to provide the catalyst with oxidation and reduction functions. In operation, the NSR catalyst promotes a series of elementary steps which are depicted below in Equations 1-5. While several reactions are depicted in equations 1-5, those skilled in the art will recognize that additional and/or different reactions may occur.

In an oxidizing environment, NO is oxidized to NO₂ (Equation 1), which is an important step for NOₓ storage. At low temperatures, this reaction is typically catalyzed by the platinum group metal component. Further oxidation of NO₂ to nitrate, with incorporation of an atomic oxygen, is also a catalyzed reaction (Equation 2). There is little nitrate formation in the absence of the platinum group metal component even when NO₂ is the main NOₓ source. The platinum group metal component has the dual functions of oxidation and reduction. For its reduction role, the platinum group metal component first catalyzes the release of NOₓ upon introduction of a reductant, e.g., CO (carbon monoxide) or HC (hydrocarbon) (Equation 3) to the exhaust. The released NOₓ is then further reduced to gaseous nitrogen (N₂) in a rich environment (Equations 4 and 5). NOₓ release may be induced by fuel injection even in a net oxidizing environment. However, the efficient reduction of released NOₓ by CO requires rich conditions.

Oxidation of NO to NO₂

NO+½O₂→NO₂ (1)

NOₓ Storage as Nitrate

2NO₂+MCO₃+½O₂→M(NO₃)₂+CO₂ (2)

NOₓ Release

M(NO₃)₂+2CO→MCO₃+NO₂+NO+CO₂ (3)

NOₓ Reduction to N₂

NO₂+CO→NO+CO₂ (4)

2NO+2CO→N₂+2CO₂ (5)

An alternative strategy for the abatement of NOₓ in the exhaust of lean burning engines uses selective catalytic reduction (SCR) catalyst technology. SCR catalyst technology uses a reductant and an SCR catalyst to reduce NOₓ to N₂. The NH₃-SCR catalysts use ammonia as a reductant and typically use catalysts composed of base metals. This technology is capable of reducing NOₓ by more than 90%. One of the potential disadvantages of NH₃-SCR technology is the use of a reservoir to house the ammonia source (e.g., urea). Another potential disadvantage of NH₃-SCR technology is the commitment of operators of these machines to replenish the reservoirs with urea as needed and infrastructure for supplying urea to the operators.

Yet another alternative strategy for the abatement of NOₓ in the exhaust of lean burning engines achieves selective catalytic reduction using hydrocarbon as a reductant instead of ammonia. These catalysts are referred to as HC-SCR catalysts. HC-SCR catalysts may be advantageous because the hydrocarbon is readily available on many machines, thereby eliminating the need for a separate system to house an ammonia source. Unfortunately, HC-SCR catalyst technology typically does not work with the catalyst used for the NH₃-SCR system (e.g., copper zeolite), due to a lack of sufficient catalytic activity. Consequently, HC-SCR catalysts typically include a catalytic component that is configured for selectively reducing NOₓ at lean burning conditions using a hydrocarbon (e.g., platinum (Pt) supported on alumina).

An example of an HC-SCR catalyst that reduces NOₓ at lean burning conditions using a hydrocarbon are disclosed in US Patent Application 2008/0069743 to Castellano. Castellano teaches the use of silver tungstate in an HC-SCR catalyst to improve the operating temperature at which the HC-SCR catalyst reduces NOₓ.

### BRIEF SUMMARY

The catalysts, systems, and methods disclosed herein provide for reduced NOₓ emissions in the exhaust stream of a lean burning engine. The catalysts include two different types of selective catalytic reduction (SCR) catalysts (i.e., two different types of catalysts that may catalytically reduce NOₓ using a reductant). The first catalyst is an SCR catalyst having a composition that produces a reductant and the second catalyst is an SCR catalyst having a composition that reduces NOₓ using the reductant produced by the first SCR catalyst. The second SCR catalyst is associated with the first SCR catalyst such that the reductant produced by the first catalyst may be used by the second SCR catalyst to reduce NOₓ.

Methods for removing nitrogen oxides (NOₓ) from an exhaust stream are also disclosed. The method may include first providing an initial exhaust gas stream from a lean burning engine where the initial exhaust gas stream includes NOₓ. The initial exhaust gas stream is introduced into a hydrocarbon selective catalytic reduction (HC-SCR) catalyst under lean burning conditions and produces ammonia, thereby yielding an intermediate exhaust gas stream that includes ammonia and NOₓ. The intermediate exhaust gas stream is introduced into an ammonia (NH₃-SCR) catalyst and at least a portion the ammonia and NOₓ is converted to N₂.

### BRIEF DESCRIPTION OF THE DRAWINGS

FIG. 1 is a schematic drawing of an emissions system according to one embodiment;

FIGS. 2-5 are cross sectional views of first and second catalysts on a substrate; and

FIG. 6 is a graph showing NOₓ reduction of the dual SCR catalysts disclosed herein compared to other known catalysts.

### DETAILED DESCRIPTION

A. Emissions Treatment Systems

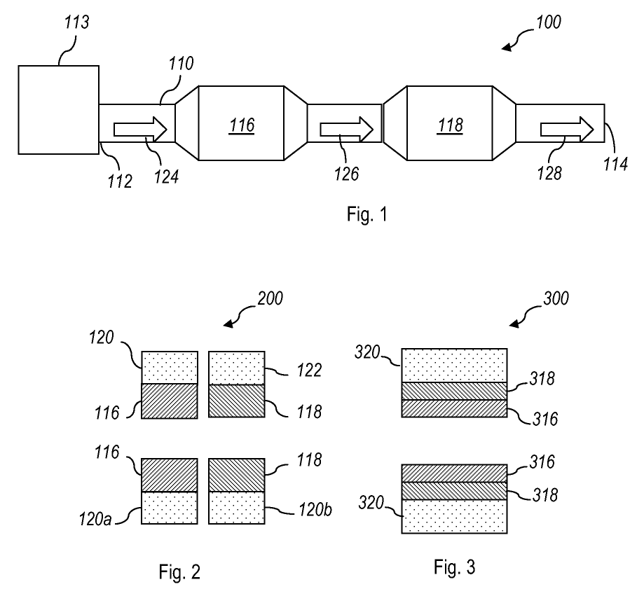

The SCR catalysts described herein may be included in an emissions system for lean burning engines. Referring to FIG. 1, an emission treatment system 100 according to one or more embodiments may include an exhaust conduit 110 having an inlet 112 configured to receive an initial exhaust gas stream 124 from a combustion engine 113 and an outlet 114 for discharging the exhaust gas stream 128 downstream from the inlet 112. A first SCR catalyst 116 is disposed upstream from a second SCR catalyst 118 and an intermediate exhaust gas stream 126 flows between first SCR catalyst 116 and second SCR catalyst 118.

The first SCR catalyst 116 and the second SCR catalyst 118 may be part of an emissions system that includes one or more additional components including, but not limited to, diesel oxidation catalysts, catalyzed soot filters, soot filters, NO₂ traps, NSR catalysts, partial hydrocarbon oxidation catalysts, air pumps, external heating devices, precious metal catalysts, sulfur traps, phosphorous traps, and the like. The first SCR catalyst 116 and the second SCR catalyst 118 may be deposited on or associated with the foregoing components, alone or in combination, and in any way, so long as the SCR catalysts can perform their desired catalytic function as described below. For example, one or more of the foregoing additional components may be positioned between engine 113 and first SCR catalyst 116; between first SCR catalyst 116 and second SCR catalyst 118, and/or after second catalyst 118.

The catalyst compositions described herein may be part of a hydrocarbon SCR (HC-SCR) system 100 where the hydrocarbons are supplied by engine controls or engine management. For example, fuel injected into engine 113 may be increased such that excess fuel is present in the exhaust stream 124 from engine 113. Alternatively, the catalyst compositions may be part of an HC-SCR system 100 in which the hydrocarbons are supplied by a separate injection device. For example, hydrocarbons may be injected into gas stream 124 within conduit 110 between engine 113 and first catalyst 116. In another embodiment, an HC-SCR system may have hydrogen added to the emissions system 100, for example using a partial oxidation reactor (POX reactor), an on board supply of hydrogen, or by using compounds or complexes that release hydrogen when they are decomposed. An HC-SCR system may be provided in which 1% or more of the first reductant contains an oxygenated carbon-containing molecule such as an aldehyde, alcohol or carbon monoxide.

The first SCR catalyst 116 is a catalyst that converts at least a portion of NOₓ to N₂ using a first reductant and also produces a second reductant. For example, in one embodiment, the first SCR catalyst 116 may be an HC-SCR catalyst that produces ammonia and the second SCR catalyst 118 may be an NH₃-SCR. The first and second SCR catalysts 116 and 118 respectively may be associated in any way so long as the second reductant produced by the first SCR catalyst 116 may be utilized to convert NOₓ to N₂ using the second SCR catalyst 118.

FIGS. 2-4 are cross sectional views of first and second catalysts on a substrate. FIGS. 2-4 illustrate example configurations showing the relative association of a first SCR catalyst 116 (e.g., HC-SCR catalyst) with a second SCR catalyst 118 (e.g., NH₃-SCR catalyst) disposed on substrates 120 and 122, respectively.

Referring to FIG. 2, first catalyst 116 and second catalyst 118 are disposed on separate substrates 120 and 122, respectively. In this embodiment, substrate 122 is positioned in the emissions system downstream of substrate 120 such that the reductant (e.g., ammonia) produced by the first SCR catalyst 116 may be used by second SCR catalyst 118 to reduce NOₓ. In addition, the system may include any number of repeating first and second SCR catalysts 116 and 118.

FIG. 3 shows an exhaust system 300 having a first catalyst 316 and a second catalyst 318 in a layer-coated configuration with respect to substrate 320. FIG. 3 illustrates a layer coating with second catalyst 318 positioned on substrate 320 and first catalyst 316 layered on top of second catalyst 318. In an alternative embodiment, a layer-coated configuration may have the first catalyst 316 positioned on substrate 320 and second catalyst 318 layered on top of first catalyst 316. Furthermore, the system may include repeating layers of first and second SCR catalysts 316 and 318, respectively. In addition, any number of intervening layers of material can be positioned between the substrate, SCR catalyst 316, and/or SCR catalyst 318.

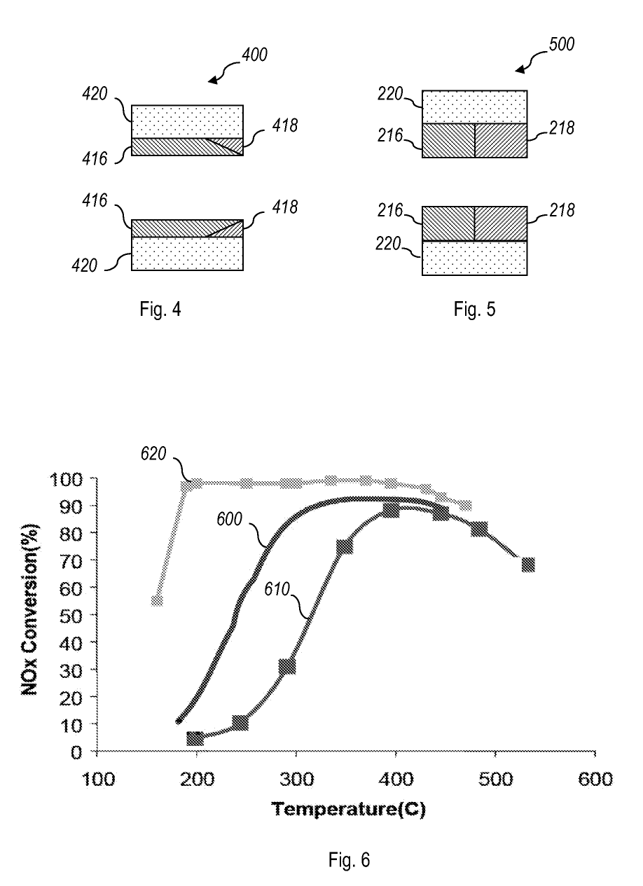

FIG. 4 shows an exhaust system 400 having a first catalyst 416 and a second catalyst 418 in a zone-layered coating on substrate 420. In FIG. 4, first catalyst 416 and second catalyst 418 are both zone coated and layer coated. First catalyst 416 partially overlaps an upstream portion of second catalyst 418. This arrangement may be formed by first depositing second catalyst and thereafter depositing first catalyst 416. However, in an alternative embodiment, an upstream portion of a second catalyst may overlap a downstream portion of the first catalyst. In yet another embodiment, first catalyst 416 can be dispersed in second catalyst 418.

FIG. 5 illustrates yet another alternative embodiment of an exhaust system 500 where a first catalyst 516 and a second catalyst 518 are disposed on a monolithic substrate 520 in a zone-coated configuration. In this embodiment, second catalyst 518 is disposed on substrate 520 downstream from first catalyst 516. In addition, any number of repeating zones may be used.

With reference to FIGS. 1 and 2, the first SCR catalyst 116 may be deposited on the substrate 120 at a concentration sufficient to ensure that the desired NOₓ reduction is achieved and/or to secure adequate durability of the catalyst. In one embodiment the first SCR catalyst 116 compositions are deposited at a concentration of at least 1 g/in³ or at least about 1.6 g/in³, or alternatively in a range from about 1.6 g/in³ to about 4.0 g/in³ of substrate (e.g., monolith).

The second SCR catalyst 118 is typically deposited on the substrate 120 in an amount sufficient to ensure suitable durability and reactivity for reducing NOₓ using the second reductant (i.e., the reductant produced by the first SCR catalyst). In one embodiment the second SCR catalyst 118 composition may be deposited in a range from roughly 1.0 g/in³ to roughly 3.6 g/in³.

The first and/or the second SCR catalysts (116 and 118) may be in the form of self-supporting catalyst particles, as a honeycomb monolith formed of the SCR catalyst compositions, or other configurations, or combinations thereof. In one or more embodiments, the SCR catalysts 116 and/or 118 are disposed as a washcoat or as a combination of washcoats on a ceramic or metallic substrate 120, such as but not limited to a honeycomb flow-through substrate.

The substrate 120 may be any material typically used for preparing catalysts, and typically includes a ceramic or metal honeycomb structure. Examples include monolithic substrates of the type having fine, parallel gas flow passages extending therethrough from an inlet or an outlet face of the substrate, such that passages are open to fluid flow therethrough (referred to as honeycomb flow through substrates). The passages, which are typically straight paths from their fluid inlet to their fluid outlet, are defined by walls on which the catalytic material may be coated as a washcoat so that the gases flowing through the passages contact the catalytic material. The flow passages of the monolithic substrate 120 are generally thin-walled channels, which may be of any suitable cross-sectional shape and size such as trapezoidal, rectangular, square, sinusoidal, hexagonal, oval, circular, etc. Such structures may contain from about 60 to about 600 or more gas inlet openings (i.e., cells) per square inch of cross section.

The substrate 120 may also be a wall-flow filter substrate, where the channels are alternately blocked, allowing a gaseous stream entering the channels from one direction (inlet direction), to flow through the channel walls and exit from the channels from the other direction (outlet direction). Either NSR and/or SCR catalyst composition may be coated on the wall-flow filter. If such substrate is utilized, the resulting system will be able to remove particulate matters along with gaseous pollutants. The wall-flow filter substrate may be made from materials, such as, but not limited to, cordierite or silicon carbide.

The ceramics useful for substrate 120 may be made of any suitable refractory material, e.g., cordierite, cordierite-alumina, silicon nitride, zircon mullite, spodumene, alumina-silica magnesia, zircon silicate, sillimanite, a magnesium silicate, zircon, petalite, alumina, an aluminosilicate, a material of comparable functionality, or combinations thereof.

The substrates 120 useful for the catalysts (SCR catalyst 116 or 118) may also be metallic in nature and be composed of one or more metals or metal alloys. The metallic substrates may be employed in various shapes such as corrugated sheet or monolithic form. Suitable metallic substrates may include heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least 15 wt % of the alloy, e.g., 10-25 wt % of chromium, 3-8 wt % of aluminum and up to 20 wt % of nickel. The alloys may also contain small or trace amounts of one or more other metals such as manganese, copper, vanadium, titanium and the like. The surface of the metal substrates 120 may be oxidized at high temperatures, e.g., 1000° C. and higher, to improve the resistance to corrosion of the alloys by forming an oxide layer on the surfaces of the substrates. Such high temperature-induced oxidation may enhance the adherence of the refractory metal oxide support and catalytically promote metal components to the substrate.

In alternative embodiments, one or more catalyst compositions may be deposited on an open cell foam substrate 120. Such substrates are typically formed of refractory ceramic or metallic materials. Substrates 122, 320, 420, and 520, described above, may be configured the same or similar to substrate 120.

B. Catalyst Compositions

According to one or more embodiments, the catalyst compositions and/or emissions systems may include any first SCR catalyst 116 that is configured to catalyze the reduction of NOₓ using a first reductant and also produce a second reductant. The first SCR catalyst 116 may include a catalytic metal that is substantially free of a platinum group metal. Also, the first SCR catalyst 116 is typically supported on a support material.

In one embodiment, the first SCR catalyst 116 is sized and configured to reduce NOₓ using a carbon-based reductant (herein referred to as “hydrocarbon SCR catalyst” or “HC-SCR catalyst”). Examples of carbon based reductants include, but are not limited to, diesel, carbon monoxide, and/or other hydrocarbons or oxides of carbon. The HC-SCR catalyst 116 may produce quantities of ammonia while reducing NOₓ using a hydrocarbon reductant. In one embodiment, the HC-SCR 116 produces ammonia in a concentration in a range from roughly 5 ppmv to roughly 50 ppmv.

In addition to producing ammonia, the HC-SCR catalyst 116 may produce an intermediate gas stream 126 with a desired ratio of NO₂ to NO. For example, the HC-SCR catalyst 116 may yield an intermediate gas stream (i.e., the gas stream between catalyst 116 and 118) with a ratio of NO₂ to NO in a range from roughly 40:60 to 60:40, or alternatively, roughly 45:55 to roughly 55:45.

Examples of catalysts that may be sized and configured to reduce NOₓ in an exhaust gas stream 126 using a first reductant and produce a second reductant include, but are not limited to, catalysts having a silver tungstate active component. The silver tungstate catalysts may be supported on a support material and may include silver in an amount between roughly 1 wt % and roughly 10 wt %.

In one embodiment, the support may be alumina such as, but not limited to, hydroxylated alumina. As used herein, the term “hydroxylated” refers to alumina that has a high concentration of surface hydroxyl groups that are introduced as the alumina is obtained. Examples of hydroxylated alumina include boehmite, pseudoboehmite or gelatinous boehmite, diaspore, nordstrandite, bayerite, and gibbsite. Pseudoboehmite and gelatinous boehmite are generally classified as non-crystalline or gelatinous materials, whereas diaspore, nordstrandite, bayerite, gibbsite, and boehmite are generally classified as crystalline. According to one or more embodiments, the hydroxylated alumina is represented by the formula Al(OH)ₓO_{y} where x=3−2y and y=0 to 1 or fractions thereof. In their preparation, such types of alumina are typically not subject to high temperature calcination, which would drive off many or most of the surface hydroxyl groups.

According to embodiments disclosed herein, substantially non-crystalline hydroxylated alumina in the form of flat, plate-shaped particles, as opposed to needle-shaped particles, may be useful in preparing catalysts. The shape of the hydroxylated alumina used in one or more embodiments is in the form of a flat plate and has an average aspect ratio of 3 to 100 and a slenderness ratio of a flat plate surface of 0.3 to 1.0. The aspect ratio is expressed by a ratio of “diameter” to “thickness” of a particle. The term “diameter” as used herein refers to a diameter of a circle having an area equal to a projected area of the particle, which may be obtained by observing the alumina hydrate through a microscope or a Transmission Electron Microscope (TEM). The slenderness ratio refers to a ratio of a minimum diameter to a maximum diameter of the flat plate surface when observed in the same manner as in the aspect ratio. Hydroxylated, flat, plate-shaped particulate aluminas which may be used in producing the first SCR catalyst 116 according to embodiments are commercially available.

Alternatively, a calcined alumina may be treated in a manner to add surface hydroxyl groups, for example, by exposing the alumina to steam for a period of time. In one or more embodiments, the alumina used for silver impregnation is substantially free of gamma alumina. The final catalyst after silver impregnation, drying, calcination, and/or hydrothermal treatment, may comprise gamma alumina or other high temperature alumina phases.

In one or more embodiments, the alumina is impregnated with a solution containing silver tungstate. The silver tungstate catalysts 116 have HC-SCR activity for the treatment of emissions from lean burning engines. The stoichiometric compound Ag₂WO₄ (or multiples thereof) supported on an alumina such as gamma alumina, boehmite or pseudoboehmite or mixtures thereof may effectively convert NOₓ to N₂ in the presence of a hydrocarbon reducing agent. Compared to a silver only compound on an alumina HC-SCR catalyst 116, similar conversions of NOₓ may be obtained with approximately one half the net silver loading using silver tungstate. The 2% silver tungstate on alumina catalyst may give similar NOₓ conversion as 2% silver (as Ag₂O) on the same alumina, although the silver (Ag₂O) loading for the silver tungstate catalyst is only one half that of silver only catalyst.

The silver tungstate catalyst 116 may be made by dissolving commercially available silver tungstate in an ammonium hydroxide solution and impregnating the alumina to the desired silver tungstate level. The resulting material is then dried and calcined to a temperature of about 540° C. The material may then be heated in 10% steam at 650° C. It has been found that silver tungstate catalysts 116 may provide high conversions over a broad temperature range of about 275° C. to 525° C.

The deposition of silver onto the surface of alumina may be achieved by various impregnation methods, including incipient wetness and wet impregnation. In the wet impregnation process, an excess amount of solution is mixed with the support, followed by evaporation of the excess liquid. The deposition of silver may also be achieved by other coating techniques such as chemical vapor deposition.

The second SCR catalyst 118 is an SCR catalyst configured to reduce NOₓ in an exhaust stream of a lean burning engine using the second reductant (i.e., the reductant produced by the first SCR catalyst 116). The second SCR catalyst 118 may include any material or combination of materials that may adsorb the second reductant produced by the first SCR catalyst 116 and/or facilitate the reaction of NOₓ with the second reductant to yield nitrogen.

In one embodiment, the second SCR catalyst 118 is an ammonia SCR catalyst. The NH₃-SCR catalyst 118 may include a base metal catalyst on a high surface area support such as, but not limited to, alumina, silica, titania, zeolite or a combination of these. The NH₃-SCR catalyst 118 may include a base metal selected from the group consisting of copper (Cu), iron (Fe) and cerium (Ce) and/or a combination of these metals, although other base metals may be used, including, but not limited to indium (In), copper (Cu), silver (Ag), zinc (Zn), cadmium (Cd), cobalt (Co), nickel (Ni), iron (Fe), molybdenum (Mo), tungsten (W), titanium (Ti), vanadium (V), and zirconium (Zr), oxides thereof, alloys thereof, or combinations thereof. Base metals generally are able to effectuate NOₓ conversion using ammonia while both the base metals and the high surface support material serve to readily adsorb the NH₃. The base metal and high surface area support such as zeolite selected may be one that adsorbs NH₃ over a relatively wide temperature range. Likewise, the base metal selected may be one that may converts NO and NO₂ to N₂ across a desired temperature range and desired range of NO/NO₂ ratios.

The second SCR catalyst 118 is associated with the first SCR catalyst 116 such that the second reductant (i.e., the reductant produced by the first SCR catalyst) is in fluid communication with the second SCR catalyst 118. The association between the first and second SCR catalysts 116 and 118, respectively, may be provided by depositing the first and second SCR catalysts on one or more substrates and/or including the catalysts within an emissions treatment system 100. Moreover, any of the foregoing components described herein with respect to SCR catalyst 116, SCR catalyst 118, and/or substrates 120 and 122 may be included in the corresponding components of systems 300, 400, and/or 500, described above (e.g., components of catalyst 116 are suitable for components of catalyst 316, etc).

C. Methods For Manufacturing Compositions

The catalyst composite may be readily prepared in one or more layers on a monolithic honeycomb substrate 120. For a two-layer washcoat, the bottom layer, finely divided particles of a high surface area refractory metal oxide such as gamma alumina may be slurried in an appropriate vehicle, e.g., water. The substrate may then be dipped one or more times in such slurry or the slurry may be coated on the substrate 120 (e.g., honeycomb flow through substrate) such that there will be deposited on the substrate 120 the desired loading of the catalytic component. Components such as the silver metals, precious metals or platinum group metals, transition metal oxides, stabilizers, promoters and the NOₓ sorbent component may be incorporated in the slurry as a mixture of water soluble or water-dispersible compounds or complexes. Thereafter, the coated substrate 120 is typically calcined by heating, e.g., at 400 to 600° C. for 1 to 3 hours.

In one or more embodiments, the slurry may be comminuted to result in substantially all of the solids having particle sizes of less than 20 microns, e.g., 1-15 microns, in an average diameter. The comminution may be conducted in a ball mill or other similar equipment, and the solids content of the slurry may be, e.g., 20-60 wt % or alternatively 35-45 wt %.

Each layer is thereafter prepared and deposited on the previously formed layer of the calcined composite in a manner to yield a catalyst as described above with respect to FIGS. 1-5. After all coating operations have been completed, the composite is then again calcined by heating, e.g., at 400 to 600° C. for 1-3 hours.

D. Methods For Reducing NOₓ

The present disclosure includes a method for reducing NOₓ in the exhaust stream of a lean burning engine using two different SCR catalysts, one of which produces a reductant. The method includes providing an initial exhaust gas stream 124 having a concentration of NOₓ. The initial exhaust gas stream 124 is obtained from the engine 113 and delivered over a hydrocarbon selective catalytic reduction (HC-SCR) catalyst 116 under lean burning conditions and the HC-SCR catalyst produces ammonia, thereby yielding an intermediate exhaust gas stream 126 that includes ammonia and NOₓ. The intermediate exhaust gas stream 126 is delivered over an ammonia (NH₃-SCR) catalyst 118 and at least a portion of the NOₓ is converted to N₂ using the ammonia produced by the HC-SCR catalyst 116.

In one embodiment, the HC-SCR catalyst 116 may include a silver tungstate active component. Surprisingly, it has been found that HC-SCR catalysts and systems that include silver tungstate may produce intermediate gas streams that include significant amounts of ammonia and/or NO to NO₂ ratios that are particularly beneficial for being reduced by ammonia in the presence of an NH₃-SCR catalyst. For example, the HC-SCR catalyst 116 may facilitate formation of an intermediate gas stream 126 that has a NO₂ to NO ratio in a range from 40:60 to 60:40, alternatively 45:55 to 55:45. These ranges of NOₓ species are particularly beneficial for removing the NOₓ in the intermediate gas stream 126 using an NH₃-SCR catalyst.

### EXAMPLE

Example 1 describes an emissions system that includes an HC-SCR catalyst 116 in combination with an NH₃-SCR catalyst 118 according to one embodiment. The HC-SCR 116 is positioned upstream from the NH₃-SCR 118 in an exhaust system from an internal combustion engine operating on diesel under lean burning conditions. The HC-SCR catalyst 116 may include a silver tungstate supported on a hydroxylated alumina support and having a silver tungstate loading of 2.5 g/in³. The NH₃-SCR catalyst 118 may include an iron zeolite with an iron loading of 3.0 g/in³.

A hydrocarbon reductant is introduced into the exhaust gas stream 124 above the HC-SCR catalyst 116 and acts as a reductant in the conversion of NOₓ to N₂ in the presence of the HC-SCR catalyst 116. Testing is carried out with a space velocity of 60,000 h⁻¹, 10% oxygen in the initial gas stream, and diesel as the hydrocarbon reductant at a C₁ to NOₓ ratio of 10. Catalyst performance is tested using a down ramp method starting at 550° C. Essentially no ammonia is present in the gas stream 124 going into the HC-SCR catalyst 116 and approximately 5% to 30% of NOₓ into the HC-SCR catalyst 116 is converted to ammonia. Ammonia out of the HC-SCR catalyst 116 is typically in a range from roughly 5 to roughly 50 ppmv (e.g. for an engine producing between 0.6 g to 1.2 g of NOₓ/brake horsepower/hour). Of the 5 to 50 ppmv of ammonia, roughly 80% to roughly 95% of NOₓ is converted to N₂ by the ammonia in the NH₃-SCR catalyst that is downstream from the HC-SCR catalyst 116. The catalyst of Example 1 and similar catalysts as described above are hereinafter referred to as a “dual SCR catalyst.”

As compared to known NOₓ reduction systems, the dual SCR catalysts and emissions treatment systems described herein may be used to achieve higher NOₓ reduction than known HC-SCR catalysts without the need for separate ammonia storage and delivery systems for ammonia. To evaluate the performance of the dual SCR catalysts and exhaust treatment systems described herein, the dual SCR catalysts were compared to traditional HC-SCR and NH₃-SCR catalysts systems. FIG. 6 is a graph showing the NOₓ reduction that may be achieved by a dual SCR catalyst emissions system 600 manufactured according to Example 1 compared with a silver tungstate HC-SCR system 610, and a NH₃-SCR system 620. The HC-SCR catalyst system 610 is operated under the same operating conditions as the dual-SCR catalyst 600. The NH₃-SCR catalyst 620 may be operated with stoichiometric equivalent concentrations of ammonia and NOₓ and an NO₂ to NO ratio in a range from roughly 50:50.

The highest NOₓ reduction is expected from the NH₃-SCR catalyst 620, which requires the use of ammonia as a reductant. However, as can be seen from the graph, emissions system 600, which uses an HC-SCR catalyst and an NH₃-SCR catalyst and hydrocarbon as reductant may achieve a NOₓ reduction more similar to the NH₃-SCR catalyst 620. Moreover, these results may be achieved without introducing an external source of ammonia. In addition, the emissions system 600 may have substantially better NOₓ reduction and/or a wider operating temperature range compared to the silver tungstate HC-SCR 610, while adding the same reductant (i.e., hydrocarbon) to the initial exhaust gas stream 124.

### INDUSTRIAL APPLICABILITY

Most diesel engines and some gasoline engines operate at lean burning conditions. The oxygen-rich fuel mixture used in lean burning engines may be advantageous for many reasons, including high fuel economy and low emissions of gas phase hydrocarbons and carbon monoxide.

The disclosed exhaust treatment systems and catalyst may be applicable to any combustion-type device such as, for example, an engine, a furnace, or any other device known in the art where it is desirable to remove NOₓ from an exhaust flow.

Examples of engines that may include the catalysts, systems, and methods disclosed herein include, but are not limited to gas, diesel, gaseous, propane, and the like. The engines may be used in applications including, but not limited to, on-highway, off road, earth moving, transportation, generators, aerospace, locomotive, marine, pumps, stationary equipment, and the like.

The catalysts, systems, and methods disclosed herein may be embodied in other specific forms without departing from the spirit or essential characteristics of the disclosure. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A catalyst composition for reducing NOₓ emissions from an exhaust gas stream of a lean burning engine comprising:
a first selective catalytic reduction (SCR) catalyst including a first catalytic material, the first SCR catalyst including a composition that reduces NOₓ in the presence of a first reductant and produces a second reductant; and
a second selective catalytic reduction (SCR) catalyst associated with the first SCR catalyst, the second SCR catalyst including a second catalytic material having, the second SCR including a composition that catalytically reduces NOₓ in the presence of the second reductant.

2. The catalyst of claim 1, wherein the second reductant includes ammonia and the second SCR catalyst is an NH₃-SCR catalyst.

3. The catalyst of claim 2, wherein the second reductant includes a hydrocarbon and the first SCR catalyst is a hydrocarbon SCR.

4. The catalyst of claim 1, wherein the first catalytic material includes silver tungstate.

5. The catalyst of claim 4, wherein the silver tungstate has a ratio of Ag₂O to WO₄ between roughly 2:1 and roughly 1:2.

6. The catalyst of claim 1, wherein the first catalytic material is supported on an alumina support that includes one or more of boehmite, pseudo boehmite, gelatinous boehmite, diaspore, nordstrandidte, bayerite, gibbsite, alumina having hydroxyl groups added to the surface, or combinations thereof.

7. The catalyst of claim 1, wherein the second SCR catalyst is an ammonia SCR (NH₃-SCR) and the second catalytic material includes one or more of indium (In), copper (Cu), silver (Ag), zinc (Zn), cadmium (Cd), cerium (Ce), cobalt (Co), nickel (Ni), iron (Fe), molybdenum (Mo), tungsten (W), titanium (Ti), vanadium (V), and zirconium (Zr), oxides thereof, alloys thereof, or combinations thereof.

8. An emissions treatment system for an exhaust stream comprising a catalyst composition according to claim 1.

9. An emission treatment system for an exhaust stream, comprising:
a first selective catalytic reduction (SCR) catalyst including a first catalytic material, the first SCR catalyst including a composition that reduces NOₓ in the presence of a first reductant and produces a second reductant;
a second selective catalytic reduction (SCR) catalyst associated with the first SCR catalyst, the second SCR catalyst including a second catalytic material having, the second SCR including a composition that catalytically reduces NOₓ in the presence of the second reductant; and
an exhaust conduit having an inlet upstream from an outlet and the first SCR catalyst being at least partially disposed within the exhaust conduit upstream from the second SCR catalyst.

10. The system of claim 9, wherein the first SCR catalyst is disposed on a first substrate and the second SCR catalyst is disposed on a second substrate.

11. The system of claim 9, wherein the first SCR catalyst and the second SCR catalyst are disposed on a monolithic substrate.

12. The system of claim 11, wherein the first SCR catalyst and the second SCR catalyst are zone coated, layer coated, zone-layered coated, or a combination thereof.

13. A system for reducing NOₓ emissions from an exhaust gas stream of a lean burning engine comprising:
an exhaust conduit having an inlet configured to receive an exhaust gas stream and an outlet for discharging the exhaust gas stream downstream from the inlet;
a hydrocarbon selective catalytic reduction (HC-SCR) catalyst disposed within the exhaust conduit, the HC-SCR catalyst including a silver tungstate catalyst; and
an ammonia selective catalytic reduction (NH₃-SCR) catalyst fluidly coupled to the HC-SCR catalyst downstream from the HC-SCR catalyst, the NH₃-SCR catalyst including a second catalytic material sized and configured to catalytically reduce NOₓ in the presence of ammonia.

14. The system of claim 13, wherein the HC-SCR catalyst and the NH₃-SCR catalyst are disposed on distinct substrates.

15. The system of claim 13, wherein the HC-SCR catalyst and the NH₃-SCR catalyst are disposed on a same substrate.

16. The system of claim 13, wherein the HC-SCR catalyst and the NH₃-SCR catalyst are zone coated.

17. A method for removing nitrogen oxides (NOₓ) from an exhaust stream comprising:
providing an initial exhaust gas stream produced under lean burning conditions, the initial exhaust gas stream having a concentration of NOₓ;
introducing the initial exhaust gas stream over a hydrocarbon selective catalytic reduction (HC-SCR) catalyst and producing ammonia, thereby yielding an intermediate exhaust gas stream that includes ammonia and NOₓ;
introducing the intermediate exhaust gas stream into an ammonia (NH₃-SCR) catalyst and converting at least a portion of the ammonia and NOₓ to N₂.

18. The method of claim 17, wherein the intermediate exhaust gas stream includes ammonia in a concentration in a range from roughly 5 ppmv to roughly 50 ppmv.

19. The method of claim 17, wherein the intermediate exhaust gas stream, has a NO:NO2 ratio between roughly 40:60 and roughly 60:40.

20. The method of claim 17, wherein the first supported metal of the HC-SCR catalyst includes silver tungstate.

21. The catalyst of claim 20, wherein the silver tungstate is supported on an alumina support.
